(19) United States
(12) Patent Application Publication
(10) Pub. No.: US 2017/0060826 A1
(43) Pub. Date: Mar. 2, 2017

(54) Automatic Sentence And Clause Level Topic Extraction And Text Summarization

(71) Applicant: Subrata Das, Belmont, MA (US)

(72) Inventor: Subrata Das, Belmont, MA (US)

(21) Appl. No.: 15/247,285

(22) Filed: Aug. 25, 2016

Related U.S. Application Data
(60) Provisional application No. 62/210,407, filed on Aug. 26, 2015.

(51) Int. Cl. G06F 17/22; G06F 17/24; G06F 17/27

(52) U.S. Cl. CPC G06F 17/2264; G06F 17/274; G06F 17/2765; G06F 17/2785; G06F 17/2705; G06F 17/24

(57) ABSTRACT

A system and method for automatic sentence and/or clause level topic extraction and text summarization to quickly render relevant textual summaries from original text of any length, including receiving input text, recognizing sentences or clauses in the input text, and extracting triples in the form of subject-action-object. Subjects referenced multiple times are combined together as one subject entry while adding, to each subject entry, multiple verb connectors and object nodes that relate to that subject entry. Each subject's level of importance is calculated and ranked based on number of objects so that topics with the highest degree edges are selected first and used as the basis of the summarization.

### CROSS-REFERENCE TO RELATED APPLICATION

This application claims priority to U.S. Provisional Application No. 62/210,407 filed on 26 Aug. 2015. The entire contents of the above-mentioned application is incorporated herein by reference.

### FIELD OF THE INVENTION

The present invention relates generally to syntactic triple-based document summarizations and more specifically it relates to an automatic sentence and clause level algorithm based topic extraction and text summarization.

### BACKGROUND OF THE INVENTION

There are more documents available for reading than anyone can read fully. There is a need to quickly render relevant textual summaries from original text of any length allowing the user to understand large bodies of lengthy text in a fraction of the time it would take to read them in their entirety.

### BRIEF SUMMARY OF THE INVENTION

An object of the present invention is to provide an automatic sentence and clause level algorithm based topic extraction and text summarization for quickly rendering relevant textual summaries from original text of any length allowing the user to understand large bodies of lengthy text in a fraction of the time it would take to read them in their entirety.

Another object is to provide an Automatic Sentence And Clause Level Algorithm Based Topic Extraction And Text Summarization that renders coherent sentence level textual summaries of user specified length relative to the original text.

Another object is to provide an Automatic Sentence And Clause Level Algorithm Based Topic Extraction And Text Summarization that extracts a user specified number of topics from the target text.

Another object is to provide an Automatic Sentence And Clause Level Algorithm Based Topic Extraction And Text Summarization that evaluates clauses and topics within the original text to generate clause level summaries of user specified length.

This invention features a system and method for automatic sentence level topic extraction and text summarization to quickly render relevant textual summaries from original text of any length, including receiving input text, recognizing sentences in the input text, and extracting triples in the form of subject-action-object. Subjects referenced multiple times are combined together as one subject entry while adding to each subject entry multiple verb connectors and object nodes that relate to that subject entry. Each subject's level of importance is calculated and ranked based on number of objects so that topics with the highest degree edges are selected first and used as the basis of the summarization.

This invention also features a system and method for automatic clause level topic extraction and text summarization to quickly render relevant textual summaries from original text of any length, including receiving input text, recognizing clauses in the input text, and extracting triples in the form of subject-action-object. Subjects referenced multiple times are combined together as one subject entry while adding to each subject entry multiple verb connectors and object nodes that relate to that subject entry. Each subject's level of importance is calculated and ranked based on number of objects so that topics with the highest degree edges are selected first and used as the basis of the summarization. The clause level summary length is likely to be less than the sentence level summarization and more precise.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a schematic block diagram of a system according to this invention;

FIG. 2 is a flowchart depicting a typical operation of the system by a user;

FIG. 3 is a schematic diagram illustrating graphically a sub-operation of the present invention with extracted triples from an example text document;

FIG. 4 is an exemplary screen shot of an implementation of extracted triples from the example text document used to generate the example graph in FIG. 3;

FIG. 5 is an exemplary screen shot of sentence level text summary generated from example graph presented in FIG. 3, with 10% one topic summary;

FIG. 6 is an exemplary screen shot of sentence level text summary generated from example graph presented in FIG. 3, with 50% one topic summary;

FIG. 7 is an exemplary screen shot of sentence level text summary generated from example graph presented in FIG. 3, with 75% one topic summary and illustration of skipped sentence;

FIG. 8 is an exemplary screen shot of clause level text summary generated from example graph in FIG. 3, demonstrating 75% one topic summary;

FIG. 9 is an exemplary screen shot of sentence level text summary generated from a bio and the corresponding triple graph, with 10% two topic summary; and

FIG. 10 is an exemplary screen shot of clause level text summary generated from the same bio and the corresponding triple graph, with 10% two topic summary and illustration of skipped clauses.

### DETAILED DESCRIPTION OF THE INVENTION

### A. Overview

Turning now descriptively to the drawings, in which similar reference characters denote similar elements throughout the several views, the Figures illustrate one construction of the present invention utilizing a system and method for automatic sentence and/or clause level topic extraction and text summarization to quickly render relevant textual summaries from original text of any length. In one construction, the system and method include receiving input text, recognizing sentences in the input text, and extracting triples in the form of subject-action-object. Subjects referenced multiple times are combined together as one subject entry while adding, to each subject entry, multiple verb connectors and object nodes that relate to that subject entry. Each subject's level of importance is calculated and ranked based on number of objects so that topics with the highest degree edges are selected first and used as the basis of the summarization. In another construction, the system and method further include recognizing and extracting clauses, instead of sentences, incorporating a number of heuristics. Here the summary length is likely to be less than the sentence level summarization.

### B. Java Programming Language

Java is a general purpose programming language generally considered to be platform independent, which theoretically allows application written in Java to be run from any computing platform.

Java Programming Language. Java is a general purpose programming language generally considered to be platform independent, which theoretically allows application written in Java to be run from any computing platform.

### C. OpenNLP

Open NLP is an open source machine learning based toolkit developed and maintained by The Apache Software Foundation. According the documentation found at their website, OpenNLP supports the most common NLP tasks, such as tokenization, sentence segmentation, part-of-speech tagging, named entity extraction, chunking, parsing, and co-reference resolution. These tasks are usually required to build more advanced text processing services. OpenNLP also includes maximum entropy and perceptron based machine learning. Our implementation is used to extract syntactic triples.

Open NLP is an open source machine learning based toolkit developed and maintained by The Apache Software Foundation. According the documentation found at their website, OpenNLP supports the most common NLP tasks, such as tokenization, sentence segmentation, part-of-speech tagging, named entity extraction, chunking, parsing, and co-reference resolution. These tasks are usually required to build more advanced text processing services. OpenNLP also includes maximum entropy and perceptron based machine learning. Our implementation is used to extract syntactic triples.

### D. Stanford Parser

Stanford Parser is one of a number of open source natural language processing libraries developed and maintained by the Stanford Natural Language Processing Group. The parser has been used as a reference point in translating natural language strings to extract clauses. Our implementation is used in clause level summary generation.

### E. Connections of Main Elements and Sub-Elements of Invention

The code for summarizing a given text and extracting topics is developed in two modules in one construction according to the present invention. In operation, the first module extracts subject-verb-object triples from the given text using a standard algorithm such as the one described by Fader et al. in 2011. See Anthony Fader, Stephen Soderland, and Oren Etzioni, “Identifying relations for open information extraction”, Proceedings of the Conference on Empirical Methods in Natural Language Processing, 2011, Pages 1535-1545. The triples form a directed graph with subject and objects as nodes, and arrows are generated from subjects to objects with corresponding verbs as labels.

The second module implements heuristics to generate the summary from the triples and the associated graph in conjunction with the text itself The decision whether a sentence is selected to be a part of a summary is taken based on the number of triples, if any, it contains.

Moreover, in one construction a particular sentence is weighted more highly for inclusion in a summary than another sentence if the subject or object in a triple it contains has a very high number of incoming or outgoing edges (i.e. degrees) of the text. Weights are also placed higher to those sentences occurring towards the beginning of the original text. The selected sentences are then concatenated in the order they appear in the original text to form the summary with a limit to the percentage limit specified in the summary. The topics are selected from subjects and objects based on their degrees of the corresponding nodes in the graph.

In one construction, the two modules are written in Java code to access both OpenNLP and the Stanford Parser application programming interface to perform natural language processing tasks. Data from these tasks is returned to the Java code modules for further processing and final presentation to the user.

### F. Operation of Preferred Embodiment

Specifically, the algorithm-based engine recognizes sentences in the input text and performs co-reference resolution. Triples in the form of subject-action-object are extracted and, in some constructions, a corresponding visually-perceptible triple graph is built where subjects and objects are nodes connected by a directed arrow from a subject to an object labeled with the extracted action of the triple. Subjects referenced multiple times appear in the graph once with multiple verb connectors and object nodes. Each subject's level of importance is calculated and ranked based on number of objects so that topics with the highest degree edges are selected first and used as the basis of the summary. Sentences are then selected stepwise until the specified summary length is achieved based on whether triples have been extracted from them that contain a topic that has been chosen for inclusion in the summary, again based on level of importance. In certain constructions, the algorithm also incorporates a number of heuristics when selecting a sentence to be part of summarization, for example distance from the beginning position of the input text and distance from the beginning of a paragraph. This allows the generated summary to utilize both language extraction and abstraction greatly enhancing the cohesion of the resulting summary.

The process can also be applied to text at the clause level where the text is examined and compressed into clauses prior to summarization. This added step does not degrade the performance of the algorithm, however resulting summaries tend to be somewhat shorter in length relative to their sentence level counterparts.

Ultimately, the user is presented with a textual summary and a list of topics the summary contains. The user also has the option of exploring the extracted triple graph which may aid in the evaluation of topic importance. Lengthy texts can be explored quickly by repeated execution of the summary, varying the number of topics chosen and/or the summary length.

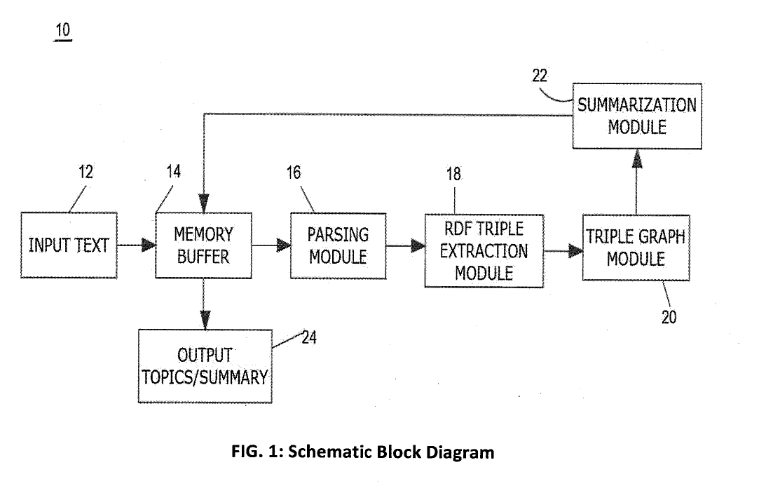

FIG. 1 depicts a system 10 as a general implementation of a system according to this invention. A body of text is ingested at an input 12 through at least one of a variety of input mechanisms and read into a memory 14. A parsing module 16 processes ingested text such that it can be passed to a module 18 for RDF (Resource Description Framework) triple extraction. Extracted triples are passed to a triple graph module 20 where a triple graph is generated and, if desired, displayed to a user. In this construction, output from module 20 is passed to an optional summarization module 22 for final generation of either a sentence level or clause level summary and topic list at output mechanism 24, preferably after being stored in memory buffer 14. In another construction, triple graph module 20 is also capable of summarization.

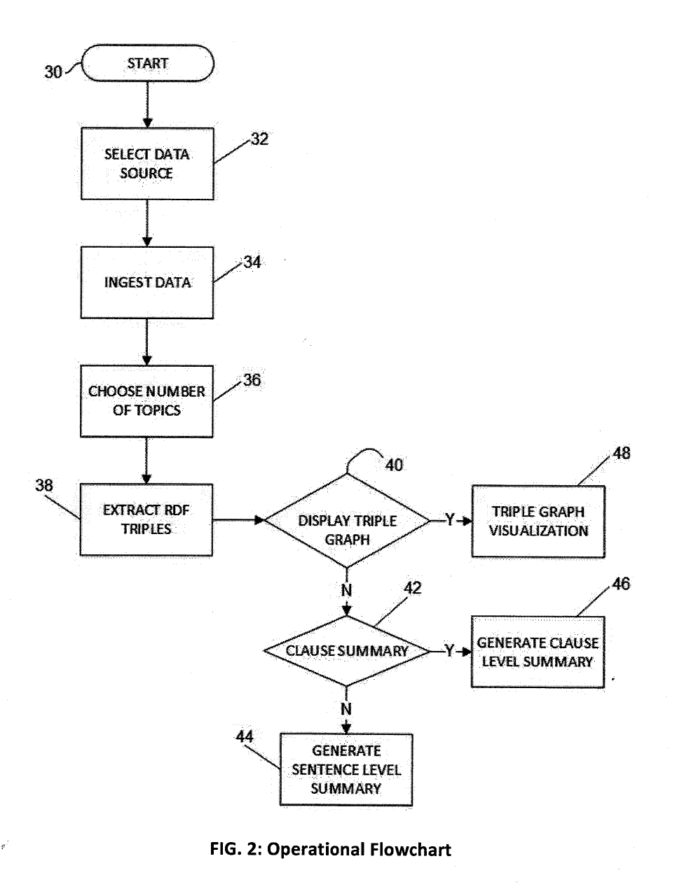

A typical interface with a user utilizing system 10 is illustrated as a flow chart in FIG. 2. The user launches aText, step 30, and selects “document summarization”, step 32, from a menu of choices. The user then selects a data source, step 34, from either a local document or one from a networked source. With the source document ingested, the user then chooses a number of topics and percentage of the document to summarize at steps 34 and 36 respectively. The user may now execute the summary by choosing either sentence level or clause level summation at 40. In one construction, RDF triple extraction is carried out at step 38 independent of whether the user has chosen, step 42, a clause level summary, step 46, or sentence level summary, step 44, and the related triple graph can be visualized independent of the summary at step 48 based on user choice. If the user does not choose to visualize the triple graph at step 44, the user is presented with the specific number of topics chosen at step 36 and a summary corresponding to the percentage chosen at the sentence or clause level based on user choice.

A pseudocode representation of the summarization algorithm is presented below:

Sentence-level Summarization Algorithm.

INPUT:

1) A body of text.

2) A measure of output summarized text in terms of a percentage of the original input text.

3) Number of topics.

OUTPUT: Summarized text and a set of topics.

STEP 1: Recognize sentences in the input text and perform co-reference resolution.

STEP 2: Extract triples in the form of subject-verb-object and build a triple graph with subject and objects are nodes and a directed arrow from a subject to an object with the label from the corresponding triple.

STEP 3: Topics of the specified numbers are selected from the set of all subjects and objects based on their degrees with the highest one first.

STEP 4: Sentences are selected based on whether triples have been extracted from them that contain topics as extracted in Step 3. A number of heuristics have been incorporated when selecting a sentence to be part of summarization, like its distance from the beginning position of the input text and whether or not it's the first sentence of a paragraph.

STEP 5: The process of sentence selection continues until the desired percentage of the summarized text is achieved.

Clause-level Summarization Algorithm.

The steps are exactly the same as the above algorithm except in STEP 1 where clauses are recognized and extracted, using a standard algorithm such as the one described by Del Corro and Gemulla in 2013. See Luciano Del Corro and Rainer Gemulla, “ClausIE: clause-based open information extraction”, Proceedings of the 22nd international conference on World Wide Web, 2013, Pages 355-366. In STEP 4 clauses are selected instead of sentences. Hence the summary length is likely to be less than the sentence level summarization.

Consider the following simple illustrative example text having five sentences:

“Dr. John Smith is a scientist. He hired Subrata. Subrata is a friend of Sam. John did not break the pot. Although Dr. Smith ate fish, he likes meat.”

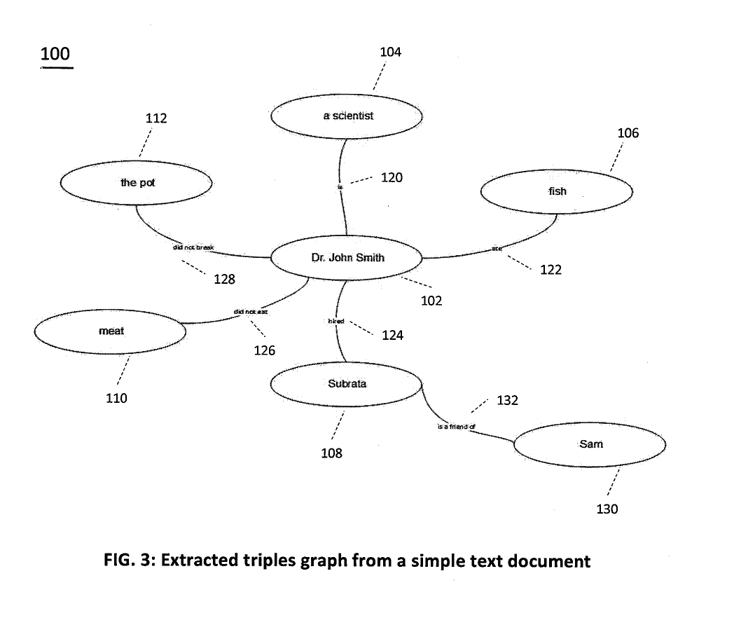

FIG. 3 depicts one example of an extracted triple graph 100 generated from this text. It shows the highest degree edge to be Dr. John Smith, shown in central subject node 102, with linked object nodes 104 (“a scientist”), 106 (“fish”), 108 (“Subrata”), 110 (“meat”), and 112 (“the pot”). The object nodes 104-112 are connected to the subject node 102 by directed arrows 120-128 labeled with actions “is”, “ate”, “hired”, “did not eat”, and “did not break”, respectively. Note that object node 130 is itself a subject that is linked by action “is a friend of” 132 to node 108. The triple formed by 108, 132 and 130 does not expressly include the central subject of “Dr. John Smith”, node 102.

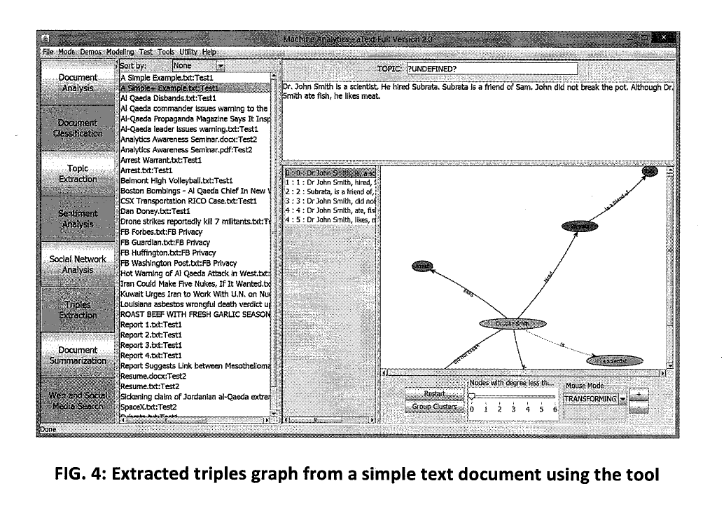

FIG. 4 is an exemplary screen shot of an implementation of extracted triples from the example text document used to generate the example graph in FIG. 3. It shows the highest degree edge to be Dr. John Smith. The algorithm for extracting graph replaces pronoun references with the actual subject of the topic (co-reference resolution).

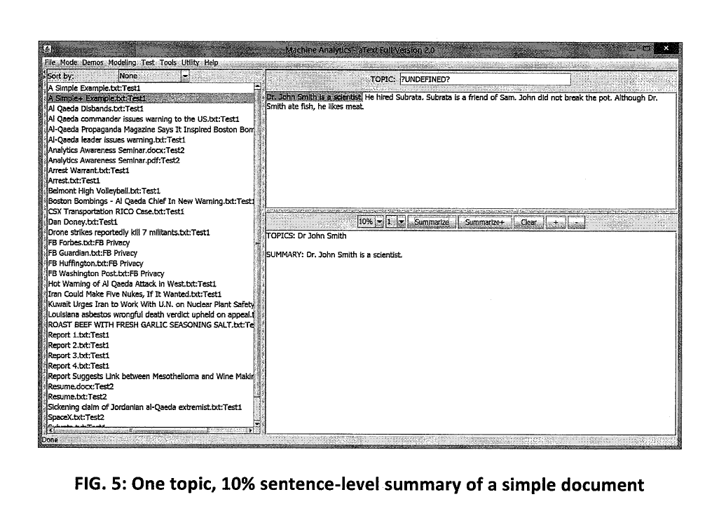

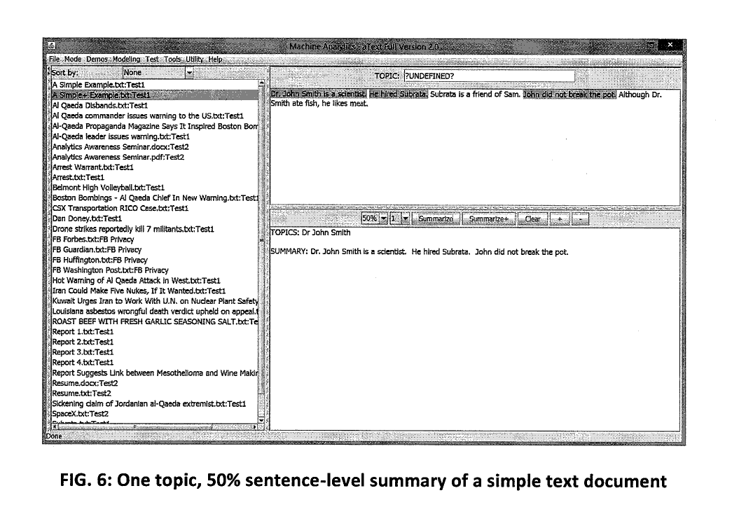

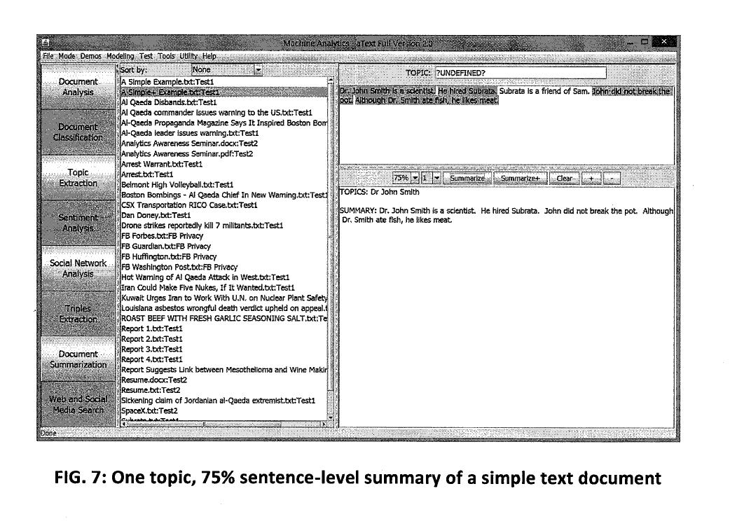

FIG. 5 shows the resulting one topic 10% summary of the example five-sentence text, where the topic selected by the algorithm is Dr. John Smith and the summary is simply the first sentence due to the length of the document and owing to the fact that the highest degree edge is contained in the first sentence. FIG. 6 shows the resulting one topic 50% summary of the example five-sentence text. FIG. 7 shows the 75%, one topic summary of the text. We can see that the algorithm skips over the sentence “Subrata is a friend of Sam” since this is not part of the first topic. The algorithm continues to select sentences based on what has been calculated as the next most important triple related to the first topic. This example is meant to be illustrative so that the techniques used can be easily understood. Longer examples yield much more complex triple graphs and the resulting summaries do not simply chose sentences in the order that they appear but rather on a calculated level of importance basis.

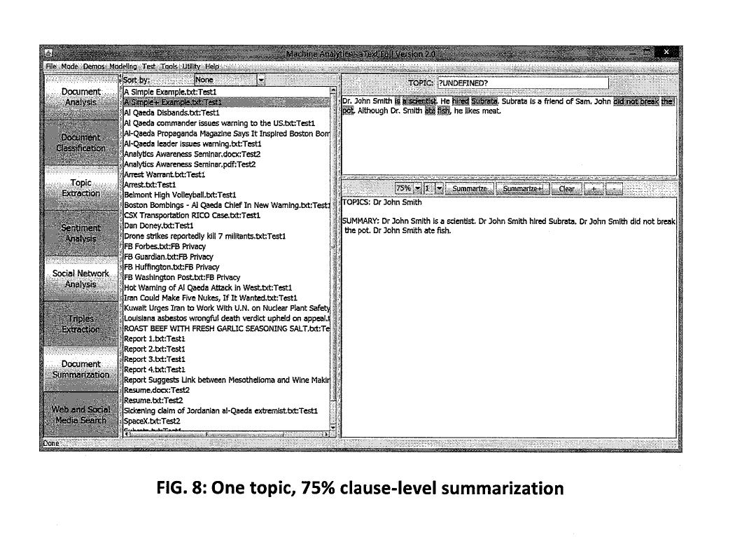

Continuing with the same example text for the purpose of direct comparison of sentence level vs. Clause level summarization, we can see in FIG. 8 a 75% summarization. Rather than highlighting entire sentences where a topic occurs, only clauses that refer to a specific topic are highlighted. The summary algorithm replaces pronoun references with the actual subject of the topic. In the example, only the first clause “Dr. Smith ate fish” from the last sentence “Although Dr. Smith ate fish, he likes meat” is kept in the clause-level summary.

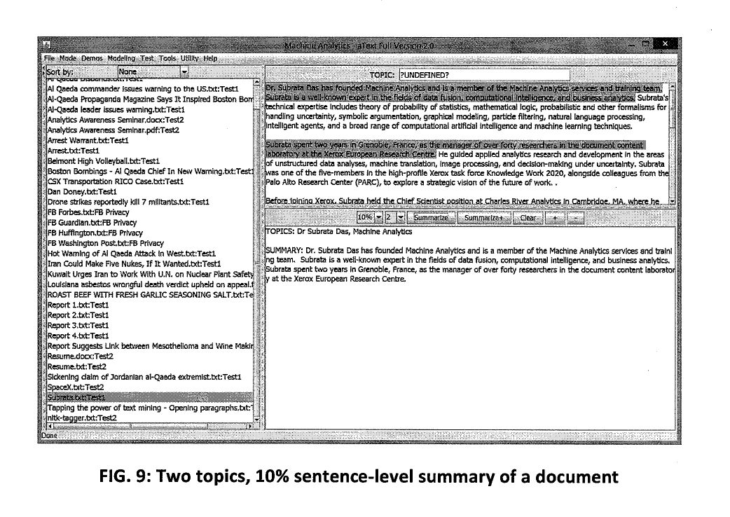

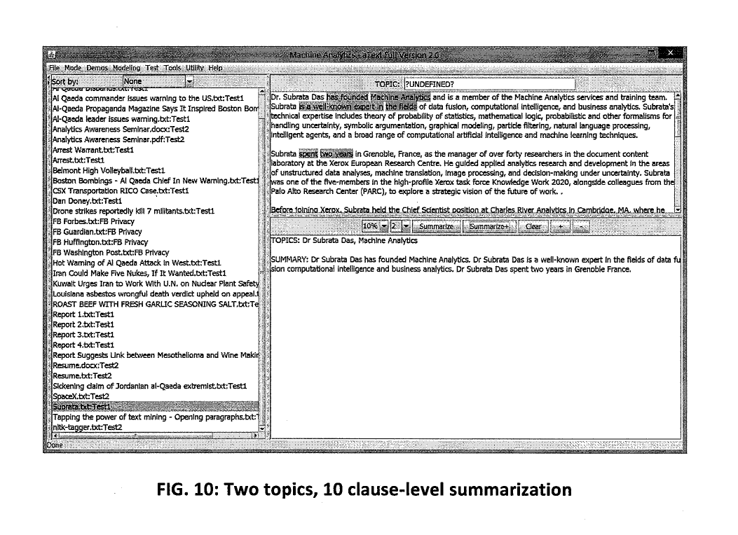

We provide another example of text summary using an example bio, larger document than the one simple example above. FIG. 9 shows a 10%, two topic summary whereas FIG. 10 shows a clause-level summary of the same desired length and topics but two clauses have been excluded from the first and third sentences.

What has been described and illustrated herein is a preferred embodiment of the invention along with some of its variations. The terms, descriptions and Figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

Although specific features of the present invention are shown in some drawings and not in others, this is for convenience only, as each feature may be combined with any or all of the other features in accordance with the invention. While there have been shown, described, and pointed out fundamental novel features of the invention as applied to one or more preferred embodiments thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

What is claimed is:

1. A method for automatic sentence level topic extraction and text summarization to quickly render relevant textual summaries from original text of any length, comprising:
receiving input text;
recognizing sentences in the input text;
extracting triples in the form of subject-action-object, and combining together subjects referenced multiple times as one subject entry while adding to each subject entry multiple verb connectors and object nodes that relate to that subject entry; and
calculating each subject's level of importance and ranking each subject based on number of objects so that topics with the highest degree edges are selected first and used as the basis of the summarization.

2. The method of claim 1 further including selecting sentences stepwise until a specified summary length is achieved based on whether triples have been extracted from them that contain a topic that has been chosen for inclusion in the summary.

3. The method of claim 2 wherein topics are chosen based on level of importance.

4. The method of claim 1 further including incorporating a number of heuristics when selecting a sentence to be part of summarization.

5. The method of claim 4 wherein the heuristics include distance from the beginning position of the input text and distance from the beginning of a paragraph to allow the generated summary to utilize both language extraction and abstraction.

6. A method for automatic clause level topic extraction and text summarization to quickly render relevant textual summaries from original text of any length, comprising:
receiving input text;
recognizing clauses in the input text;
extracting triples in the form of subject-action-object, and combining together subjects referenced multiple times as one subject entry while adding to each subject entry multiple verb connectors and object nodes that relate to that subject entry; and
calculating each subject's level of importance and ranking each subject based on number of objects so that topics with the highest degree edges are selected first and used as the basis of the summarization.

7. The method of claim 6 further including selecting clauses stepwise until a specified summary length is achieved based on whether triples have been extracted from them that contain a topic that has been chosen for inclusion in the summary.

8. The method of claim 7 wherein topics are chosen based on level of importance.

9. The method of claim 6 further including incorporating a number of heuristics when selecting a clause to be part of summarization.

10. The method of claim 9 wherein the heuristics include distance from the beginning position of the input text and distance from the beginning of a paragraph to allow the generated summary to utilize both language extraction and abstraction.
